(19) United States
(12) Patent Application Publication
(10) Pub. No.: US 2011/0232101 A1
(43) Pub. Date: Sep. 29, 2011

(54) UNITARY CARTRIDGE

(75) Inventors: Young Ho Park, Gyeonggi-do (KR); Hyun Seok Moon, Gyeonggi-do (KR)

(73) Assignee: DORCO CO., LTD., Yongin-si,Gyeonggi-do (KR)

(21) Appl. No.: 13/132,078

(22) PCT Filed: Jan. 28, 2010
(86) PCT No.: PCT/KR2010/000522

§ 371 Date: May 31, 2011

(30) Foreign Application Priority Data
Feb. 11, 2009 (KR) 10-2009-0010908

(51) Int. Cl. B26B 21/22

(52) U.S. Cl. 30/50

(57) ABSTRACT

The present invention relates to a shaving razor cartridge, comprising: an upper housing having one or more curved razor blades, an exposing portion for exposing the edges of the razor blades to the outside, and a guard; and a lower housing coupled to the upper housing, having a blade mounting portion for supporting the razor blades, wherein the bottoms of said one or more razor blades are supported at both ends and the center of the blade mounting portion, and both ends of said razor blades have notches such that the tops of the razor blades are supported and vertically connected to both ends of the upper housing. As the notches are formed at both ends of the razor blades to enable the razor blades to be accommodated in the space between the blade mounting portion and the upper housing, the necessity of a clip for fixing razor blades is eliminated, and the deformation of the razor blades can be prevented, thus making products slim and small-sized, and enabling the automatic assembly of cartridges of a variety of shapes and reducing production costs.

### TECHNICAL FIELD

The present invention relates to a cartridge used for a wet shaving razor. The wet shaving razor includes a handle and a cartridge, wherein the cartridge includes one or more razor blades and a guard accommodated in a plastic housing thereof. Such configuration supports the razor blades in a certain direction, and guides the hair in a certain direction for shaving, thereby preventing a deformation of the razor blades and enabling a feeling of smooth shaving.

### BACKGROUND ART

A basic function of a shaving razor is to cut and remove the hair including mustache. In the case of a general wet shaving razor, the cartridge includes one or more razor blades, a guard and a lubricant band to adhere to the skin and cut the hair without difficulty. A classic example of such cartridge is disclosed by the U.S. Pat. No. 6,029,354, and is shown in FIGS. 1 and 2.

As shown in FIGS. 1 and 2, a cartridge 14 includes a housing which accommodates therein three razor blades 18; a clip 68 which fixes the razor blades 18 to the housing, and a guard 20 and a cap 22. The housing includes a slot 58 which is formed in internal both surfaces 60 to accommodate bottoms 59 welded to the razor blades 18, and elastic portions 62 to elastically support the razor blades 18.

The clip 68 is fixed to the inside of a protruding edge 70 to surround the bottom of the housing and to support the tops of the razor blades 18 within the housing.

The guard 20 includes an elastomer unit which has a pin formed therein and mounted in a front side of the housing to contact and extend a user's skin.

As such, in a conventional wet shaving razor, the clips 68 surround the both ends of the housing accommodating the razor blades therein to thereby fix the bottoms 59 of the razor blades to the slot 58 and support the both ends of the razor blades 18 by the clips 68.

However, the foregoing configuration has the following problems:

First, in manufacturing a cartridge, after the unitary razor blade portion is arranged in the housing after the welding of the razor blades and the bottoms, a process of surrounding the razor blades with clips is required.

Second, when the clips are coupled to the housing, in the case when one or more razor blades are used to press the clips to fix the razor blades to the housing and in the case when the clips are pressed as a result of developing of various types of housings, the clips are deformed depending on the shape of both ends of the housing and the portion thereof contacting the razor blades become ununiform. Then, the location of the razor blades receiving a certain force during a shaving is deformed and the shaving performance deteriorates.

Third, a contact portion of the clips including metal and the razor blades is the most damaged portion during shaving, and the razor blades cannot help but be rusted due to moisture which is a feature of the wet shaving razor.

### DISCLOSURE

### Technical Problem

The present invention has been made to solve the problems and it is an object of the present invention to provide a unitary cartridge which prevents a damage to a portion contacting razor blades due to a clip including a metal material, prevents a deformation of a location of the razor blade arising from a manufacturing process or during a shaving due to the clip used to safely seat the razors blade in the housing, and omits a secondary manufacturing process of surrounding the housing with the clips in the manufacturing process of the cartridge.

### Technical Solution

In order to achieve the object of the present invention, a unitary cartridge comprises one or more curved razor blades.

The unitary cartridge comprises an upper housing which comprises an exposing portion to expose edges of the razor blades to the outside, and an elastic guard.

The unitary cartridge comprises a lower housing which is coupled to the upper housing and comprises a blade seater to support the razor blades.

The bottoms of the one or more razor blades are supported in both ends and the center of the blade seater, tops of the razor blades are supported in both ends of the upper housing and vertically, and the unitary cartridge is coupled between the lower housing and the upper housing.

The upper housing is coupled to the lower housing in which the notches are stably seated by hook to form a unitary cartridge to thereby remove clips from the cartridge, prevent a deformation of the razor blades, make a slim cartridge and ensure an automatic assembly of the cartridge without difficulty.

### Advantageous Effect

A unitary cartridge according to the present invention does not require clips to stably seat razor blades in a housing include a lower housing having notches stably seated therein and an upper housing coupled to the lower housing, omits an additional fixing member of clips and prevent a deformation of the razor blades due to the clips coupled to various types of cartridges in the manufacturing process of the cartridge. Accordingly, this enables a slim and small-sized cartridge and an automatic assembly of various types of cartridges without difficulty and reduces production costs.

### BRIEF DESCRIPTION OF DRAWINGS

FIG. 1 is an exploded view of a conventional shaving razor cartridge.

FIG. 2 is a sectional view of the shaving razor cartridge in FIG. 1.

FIG. 3 is an exploded view of a shaving razor cartridge according to the present invention.

FIG. 4 is a sectional view of the shaving razor cartridge in FIG. 3.

FIG. 5 is a perspective view of a lower housing of the shaving razor according to the present invention.

FIG. 6 is a perspective view of main parts of a razor blade which is stably seated in the lower housing according to the present invention.

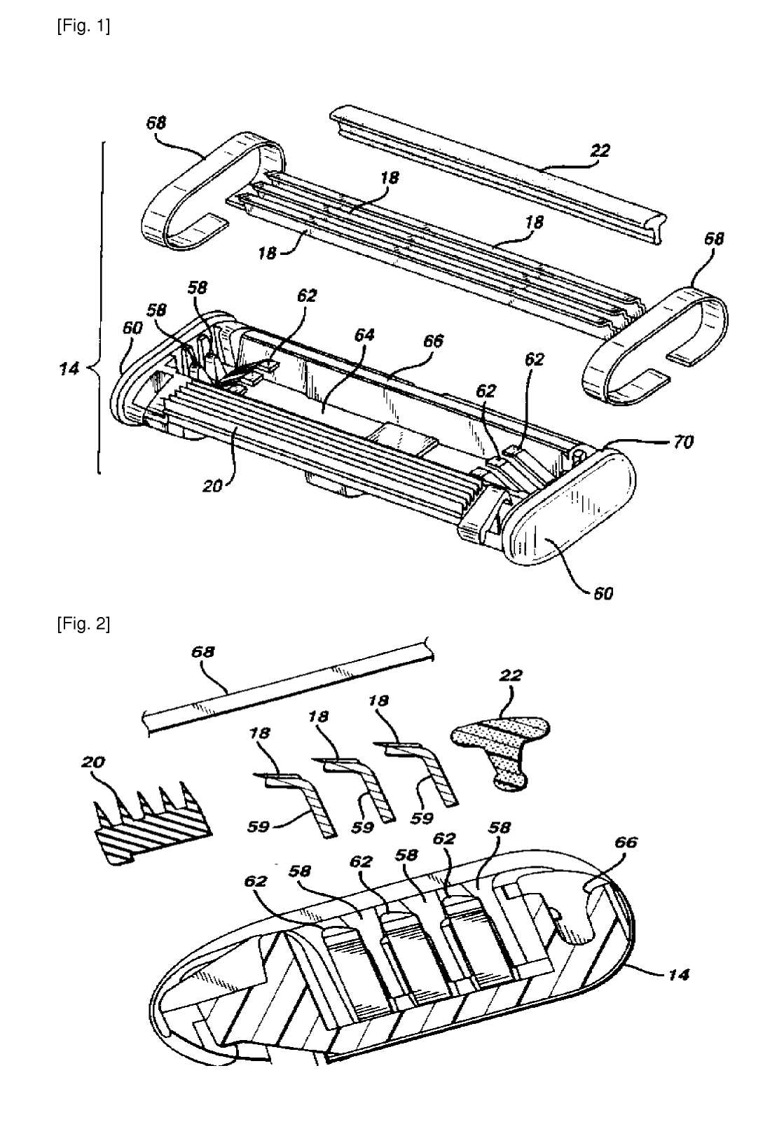

### BEST MODE

Hereinafter, a detailed structure and operation of a cartridge according to exemplary embodiments of the present invention will be described with reference to accompanying drawings.

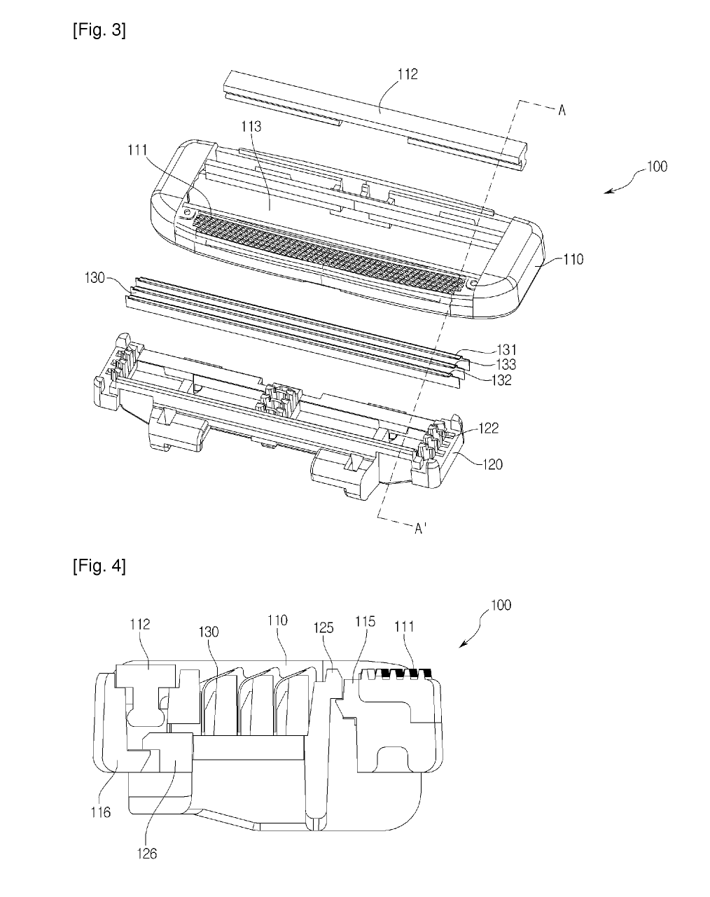

FIG. 3 is an exploded view of a shaving razor cartridge according to the present invention. FIG. 4 is a sectional view of the shaving razor cartridge as assembled in FIG. 3.

As shown in FIG. 3, a cartridge 100 of a shaving razor according to the present invention includes razor blades 130, a lower housing 120 in which the razor blades 130 are stably seated, and an upper housing 110 which includes an exposing portion 113 to expose edges of the razor blades 130 to the outside.

The upper housing 110 includes a guard 111 which is provided in a front end thereof and includes an elastic material, and a lubricant band 112 which is provided in a rear end thereof. The material of the upper housing 110 according to the present exemplary embodiment includes synthetic resins, but not limited thereto, and may further include wood, metal or the like.

The guard 111 includes an elastomer unit which has a pin formed therein and is mounted in a front end of the upper housing 110 to contact and extend a user's skin. The lubricant band 112 is installed in a rear end portion of the upper housing 110 to protect moisture of the skin and to smooth the skin, and may include chamomile, olive, allantoin or pearl ingredient.

The razor blades 130 cut hair including mustache. Edges 131 which include an edgy end are formed in a surface of the razor blade 130, and a razor blade supporter 130 is formed in another surface of the razor blades 132, The razor blades 130 include a curved portion 133 and have a [symbol] shape.

FIG. 4 is a sectional view of the cartridge, taken along line A-A′ in FIG. 3, and illustrates a coupling state of the upper housing 110 and the lower housing 120. The upper housing 110 includes the guard 111 which is provided in the front end thereof, a first hook seating portion 115 which is provided in the internal side adjacent to the guide 111, the lubricant band 112 which is installed in the rear end thereof and a second hook seating portion 116 which is provided in the internal side adjacent to the lubricant band 112.

The lower housing 120 includes a first hook 125 which is provided in the external side in a direction of the edges of the razor blades and is coupled to the first hook seating portion 115, and a second hook 126 which is provided in the external side in an opposite direction to the direction of the edges of the razor blades and is coupled to the second hook seating portion 116.

The first hook 125 of the lower housing 120 supporting one or more razor blades 130 is chucked and coupled to the first hook seating portion 115 of the upper housing 110, and the second hook 126 of the lower housing 120 is chucked and coupled to the second hook seating portion 116 of the upper housing 110.

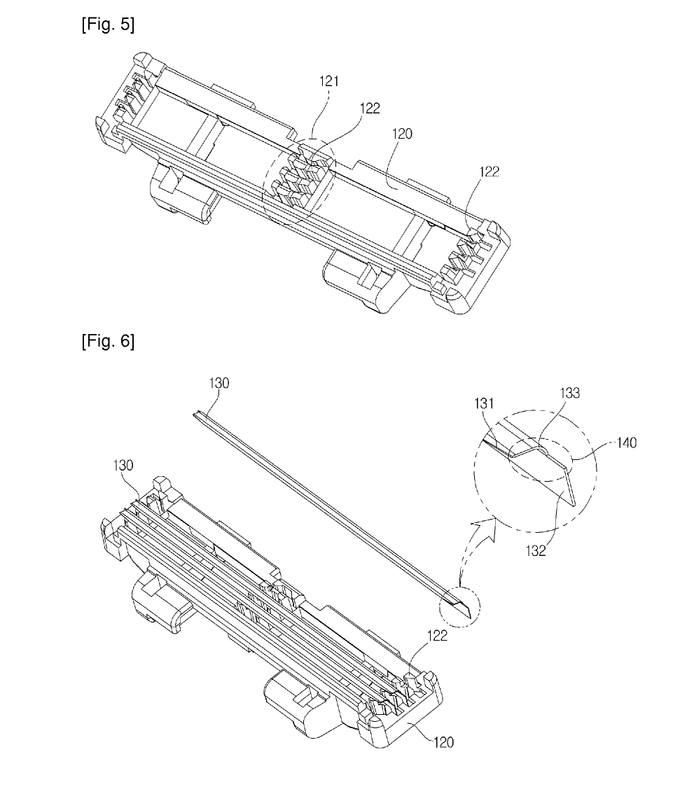

FIG. 5 is a perspective view of the lower housing 120 of the shaving razor according to the present invention. The lower housing 120 includes a blade seating and supporting portion 121 which is provided in the center and both ends of the razor blades 130 to seat and support one or more razor blades 130. The blade seating and supporting portion 121 includes blade seaters and supporters 122 in the number which is at least one or more than the number of the razor blades 130. The razor blade supporter 132 is stably seated in and fixed to the blade seaters and supporters 122 of the blade seating and supporting portion 121 provided in internal opposite ends of the lower housing 120.

FIG. 6 illustrates main parts of the razor blades which are stably seated in the lower housing 120. The razor blades 130 include edges 131 which have an edgy end, the razor blade supporter 132 in another surface, and notches 140 in opposite ends with a curved portion 133 having a [symbol] shape in both surfaces. The notches 140 include the edges which are notched by cutting an upper portion including edge 131 and the curved portion 133 at the both ends of the razor blades 130 and the razor blade supporter 132 excluding the curved portion 133. The upper portion of the notches is curved on the basis of the boundary of the razor blade supporter 132.

The razor blades 130 which include the notches 140 are inserted into the blade seaters and supporters 122 of the lower housing 120, and the lower housing 120 is coupled to the upper housing 110 by hook and forms the unitary cartridge. The upper portion of the blade supporter 132 of the notches 140 contacts the internal side of the upper housing 110 and is supported partially thereby, and the razor blade supporter 132 is inserted into the blade seaters and supporters 122 and partially supported thereby. Then, an additional clip is not required to be installed in the cartridge. The manufacturing process of the cartridge includes 1) a razor blade manufacturing process and 2) an upper housing coupling process immediately after the razor blades are stably seated in the lower housing to form the cartridge. This enables a slimmer and smaller cartridge, ensures an automatic assembly process without difficulty and reduces defects in manufacturing cartridges.

1. A unitary cartridge comprising:
one or more curved razor blades;
an upper housing which comprises an exposing portion to expose edges of the razor blades to the outside, and an elastic guard;
a lower housing which is coupled to the upper housing and comprises a blade seater to support the razor blades, wherein
bottoms of the one or more razor blades are supported in both ends and the center of the blade seater, tops of the razor blades are supported in both ends of the upper housing and vertically, and the unitary cartridge is coupled between the lower housing and the upper housing.

2. The unitary cartridge according to claim 1, wherein the lower housing comprises a hook coupler which is coupled to a lower end of the upper housing by hook.

3. The unitary cartridge according to claim 1, wherein the blade seater comprises a plurality of blade seater and supporter in both ends of the lower housing to fix the razor blades.

4. The unitary cartridge according to claim 1, wherein the razor blades comprise notches in both ends to be coupled to both ends of the upper housing vertically.
